(19) United States
(12) Patent Application Publication
(10) Pub. No.: US 2026/0056530 A1
(43) Pub. Date: Feb. 26, 2026

(54) ELECTRONIC DEVICE SUPPORTING MANUFACTURE OF SEMICONDUCTOR DEVICE AND OPERATING METHOD OF ELECTRONIC DEVICE

(71) Applicant: SAMSUNG ELECTRONICS CO., LTD., SUWON-SI (KR)

(72) Inventors: JUNHYUNG KIM, Suwon-si (KR); HYOUNGJUN KIM, Suwon-si (KR); JUNGWOO SONG, Suwon-si (KR); JUNGHWAN LEE, Suwon-si (KR); IL-WOO JUNG, Suwon-si (KR); SEOKYEONG KIM, Suwon-si (KR); HYUNMIN KIM, Suwon-si (KR); JULEE KIM, Suwon-si (KR); SUJAE HEO, Suwon-si (KR)

(21) Appl. No.: 19/261,241

(22) Filed: Jul. 7, 2025

(30) Foreign Application Priority Data
Aug. 21, 2024 (KR) 10-2024-0112356

(51) Int. Cl. G05B 19/4099

(52) U.S. Cl. CPC G05B 19/4099; G05B 2219/45031

(57) ABSTRACT

A method supporting manufacture of semiconductor dies, the method includes obtaining process data of the semiconductor dies, wherein the semiconductor dies include first dies, second dies, and third dies, obtaining measurement data associated with features of the first dies, encoding the process data to obtain preprocessed process data, generating first prediction data representing features of the second dies based on the measurement data and the preprocessed process data, computing second prediction data representing features of the third dies based on the measurement data and the first prediction data, and generating full-die level information representing features of the semiconductor dies based on the measurement data, the first prediction data, and the second prediction data.

### CROSS-REFERENCE TO RELATED APPLICATIONS

This U.S. non-provisional patent application claims priority under 35 U.S.C. § 119 to Korean Patent Application No. 10-2024-0112356 filed on Aug. 21, 2024, in the Korean Intellectual Property Office, the disclosures of which are incorporated by reference herein in their entireties.

### BACKGROUND

Embodiments of the present disclosure relate to an electronic device, and more particularly, relate to an electronic device supporting the manufacture of a semiconductor device by performing learning, inference, and computation for inferring features of semiconductor dies and an operating method of the electronic device.

A semiconductor device is manufactured through various processes. With the advancement of the technology in the designing of semiconductor device, the number of processes used for manufacturing a semiconductor device is increased, and the complexity of each process is also increased. As the number of processes and the complexity increase, various defects may occur due to an error in the process of manufacturing a semiconductor device.

In some cases, as the degree of integration of a semiconductor device increases and a nano-scale manufacturing technology develops, the number of patterns included in a semiconductor layout is also increasing. Accordingly, the amount of computation for monitoring the error or defects occurring in the semiconductor manufacturing process also increases.

In some cases, a wafer map may represent various characteristics of a plurality of semiconductor dies fabricated on a wafer. The wafer map may be used to sort (or select) a plurality of semiconductor dies and to check a yield rate of production. However, a way to measure the plurality of semiconductor dies individually and generating the wafer map is costly and time consuming. Accordingly, there is need for a method for reducing costs and time in the process of monitoring the plurality of semiconductor dies.

### SUMMARY

Embodiments of the present disclosure provide an electronic device supporting the manufacture of a semiconductor device with improved reliability and the reduced amount of computation and an operating method of the electronic device.

A method, apparatus, non-transitory computer readable medium, and system supporting manufacture of semiconductor dies are described. One or more aspects of the method, apparatus, non-transitory computer readable medium, and system include obtaining, using a processor, process data of the semiconductor dies, wherein the semiconductor dies include first dies, second dies, and third dies, obtaining, using the processor, measurement data associated with features of the first dies, encoding the process data to obtain preprocessed process data, generating, using a machine learning module, first prediction data representing features of the second dies based on the measurement data and the preprocessed process data, computing, using an arithmetic module, second prediction data representing features of the third dies based on the measurement data and the first prediction data, and generating, using the processor, full-die level information representing features of the semiconductor dies based on the measurement data, the first prediction data, and the second prediction data.

A method, apparatus, non-transitory computer readable medium, and system supporting manufacture of semiconductor dies are described. One or more aspects of the method, apparatus, non-transitory computer readable medium, and system include performing a first manufacturing process on semiconductor dies, wherein the semiconductor dies include first dies, second die, and third dies, obtaining first process data and first measurement data of a feature of the first dies, generating, using a machine learning module, first prediction data of the second dies based on the first process data and the first measurement data, computing, using an arithmetic module, second prediction data of the third dies based on the first measurement data and the first prediction data, generating the first feature data including full-die level information of the semiconductor dies based on the first measurement data, the first prediction data, and the second prediction data, obtaining second process data by performing a second manufacturing process, training a machine learning module based on the first feature data and second process data and generating, using the trained machine learning model, second feature data of the semiconductor dies.

An electronic device supporting manufacture of semiconductor dies includes at least one processor, at least one memory configured to store process data of the semiconductor dies and measurement data associated with features of first dies among the semiconductor dies, a machine learning module comprising parameters stored in the at least one memory and trained to generate first prediction data associated with the features of second dies among the semiconductor dies based on the measurement data and encoded process data of the process data; and an arithmetic module comprising parameters stored in the at least one memory and configured to compute second prediction data associated with the features of third dies among the semiconductor dies based on the measurement data and the first prediction data, and generate full-die level information based on the measurement data, the first prediction data, and the second prediction data, wherein the full-die level information representing features of the semiconductor dies.

### BRIEF DESCRIPTION OF THE FIGURES

FIG. 1 illustrates a wafer monitoring system according to an embodiment of the present disclosure.

FIG. 2 illustrates an electronic device according to an embodiment of the present disclosure.

FIG. 3 illustrating an example of a plurality of wafers in which a plurality of semiconductor dies are manufactured according to an embodiment of the present disclosure.

FIG. 4 illustrates an example of an operating method of an electronic device according to an embodiment of the present disclosure.

FIG. 5 illustrates an example of an operation of a machine learning module according to an embodiment of the present disclosure.

FIG. 6 illustrates an example of a preprocessing operation of an electronic device according to an embodiment of the present disclosure.

FIGS. 7A and 7B illustrates an example in which an electronic device is trained and performs inferencing according to an embodiment of the present disclosure.

FIGS. 8 and 9 illustrates examples in which an electronic device performs computation according to embodiments of the present disclosure.

FIG. 10 illustrates an example in which an electronic device performs computation on a wafer according to an embodiment of the present disclosure.

FIGS. 11A, 11B, and 11C illustrate examples of results of computation which an electronic device performs on a wafer of FIG. 10.

FIG. 12 illustrates an example of an operating method of an electronic device according to an embodiment of the present disclosure.

### DETAILED DESCRIPTION

Hereinafter, embodiments of the present disclosure are described in detail and clearly to such an extent that an ordinary one in the art may easily carry out the present disclosure. The same reference numerals are used for the same components in the drawings, and redundant descriptions thereof may be omitted.

It will be understood that, although the terms “first,” “second,” etc. may be used herein to describe various elements, these elements should not be limited by these terms. These terms are only used to distinguish one element from another element. For example, a first element discussed below could be termed a second element without departing from the teachings and spirit of the present disclosure. Similarly, the second element could also be termed the first element.

In the present disclosure, components which are described with reference to the terms “unit”, “module”, “block”, “˜er or ˜or”, etc. and function blocks which are illustrated in drawings is implemented in the form of software or hardware or a combination thereof. For example, the software may include a machine code, firmware, an embedded code, and application software. For example, the hardware may include an electrical circuit, an electronic circuit, a processor, a computer, an integrated circuit, integrated circuit cores, a pressure sensor, an inertial sensor, a microelectromechanical system (MEMS), a passive element, or a combination thereof.

Embodiments of the present disclosure provide a method and system for predicting full-die level information in semiconductor manufacturing. In some aspects, the electronic device includes a machine learning module and an arithmetic module that enables the electronic device to effectively generate features of unmeasured semiconductor dies based on measured data of a group of the measured semiconductor dies, process data, and geometric features. This is achieve using an encoder, a machine learning module, and an arithmetic module. For example, the encoder encodes the process data to generate preprocessed data, which allows the system to generate predictions more efficiently. The machine learning module includes one or more boosting models that accurately generate the first prediction data including features of unmeasured semiconductor dies of the reference dies. The arithmetic module includes interpolation and extrapolation algorithms that efficiently generates second prediction data including features of the remaining dies.

In some aspects, the system generates first prediction data (PD1) using a machine learning module based on the process parameters and measured characteristics of sampled dies. The first prediction data is used for further predictions using arithmetic modules, where second prediction data is generated to infer characteristics of additional dies across the wafer. By combining the first prediction data and the second prediction data, the system can generate full-die level information, ensuring comprehensive analysis of variability and uniformity across semiconductor dies.

In some aspects, by using a machine learning module to predict unmeasured die characteristics, the system minimizes the need for exhaustive physical measurements, thereby reducing computational overhead and operational complexity. The integration of boosting models within the machine learning module increases the robustness and accuracy of predictions (e.g., the first prediction data and the second prediction data). Accordingly, the embodiments of the present disclosure enable efficient analysis of complex data, optimizing manufacturing processes, and improving the overall quality and yield of semiconductor devices.

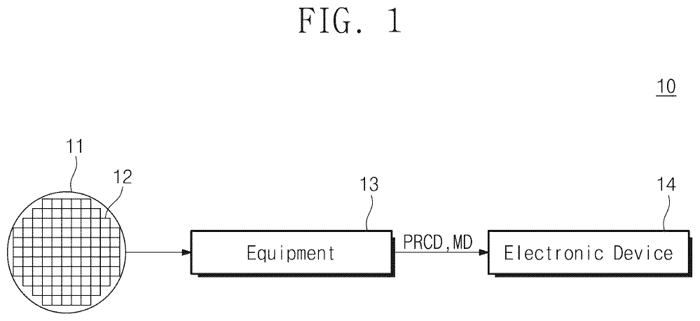

FIG. 1 illustrates a wafer monitoring system according to an embodiment of the present disclosure. A wafer monitoring system 10 may be also referred to as a “wafer test system”, a “wafer map generation system”, a “semiconductor manufacturing process monitoring system”, or a “semiconductor manufacturing system”.

Referring to FIG. 1, the wafer monitoring system 10 may include equipment 13 and an electronic device 14. In an embodiment, the equipment 13 may refer to an equipment (or a system, apparatus, etc.) for the manufacture of semiconductor dies or equipment (or a system, apparatus, etc.) for testing semiconductor dies or a wafer. A plurality of semiconductor dies 12 may be disposed or formed on a wafer 11.

In an embodiment, each of the plurality of semiconductor dies 12 may be used to form a memory device such as a dynamic random access memory (DRAM) device, a static random access memory (SRAM) device, a thyristor random access memory (TRAM) device, a NAND flash memory device, a NOR flash memory device, a resistive random access memory (RRAM) device, a ferroelectric random access memory (FRAM) device, a phase change random access memory (PRAM) device, or a magnetic random access memory (MRAM) device. In some embodiments, each of the plurality of semiconductor dies 12 may be used to form a processing device such as a central processing unit (CPU), an image signal processing unit (ISP), a digital signal processing unit (DSP), a graphics processing unit (GPU), a vision processing unit (VPU), or a neural processing unit (NPU). In some embodiments, each of the plurality of semiconductor dies 12 may be further used to form a system on chip (SoC), an application specific integrated circuit (ASIC), or a field-programmable gate array (FPGA).

The equipment 13 may obtain process data PRCD associated with one or more processes which are applied to the wafer 11 or the plurality of semiconductor dies 12. For example, the equipment 13 may receive or obtain the process data PRCD from the wafer 11 or other equipment. The equipment 13 may transmit the process data PRCD to the electronic device 14.

In an embodiment, the process data PRCD may include design layout data for the semiconductor dies 12, equipment data associated with each process, recipe data associated with each process, reticle data associated with each process, etc. However, the present disclosure is not limited thereto. For example, the process data PRCD may include a variety of data associated with processes applied to (or performed on) the semiconductor dies 12.

In an embodiment, the equipment data associated with each process may include equipment driving information. For example, equipment data may include information about a time during which equipment (e.g., equipment 13) is driven, information about pressure which equipment (e.g., equipment 13) applies to the wafer 11, etc.

The equipment 13 may test and measure characteristics or features of the wafer 11. For example, the equipment 13 may test and measure the characteristics for each semiconductor die 12 including a gate-induced drain leakage (GIDL), a drain-induced barrier lowering (DIBL), a current, a power, an operating frequency, a threshold voltage, a latency, a timing margin, a lifetime, etc. For example, the equipment 13 may test and measure geometric features associated with patterns formed in the plurality of semiconductor dies 12 or edges of the patterns. The edges of the patterns may indicate corners of the patterns. Each of the features may indicate a geometric feature associated with patterns formed in the plurality of semiconductor dies 12 or edges of the patterns.

In an embodiment, the feature may refer to a size. For example, the feature may indicate the size of each of the patterns or the size (e.g., a length) of each of the edges of the patterns. For example, the feature may indicate the width of each of the patterns or the interval (or space) between patterns.

In an embodiment, the feature may refer to a displacement. For example, the feature may indicate the influence of a neighboring pattern(s) on each of the patterns or the influence of an edge(s) of the neighboring pattern(s) on each of the edges of the patterns.

In an embodiment, the feature may refer to an interval. For example, the feature may indicate the interval between patterns or the interval between edges of the patterns. In an embodiment, the feature may refer to a vector. For example, the feature may indicate a sum of influences which neighboring patterns in a given region have on each of patterns or a sum of influences which neighboring patterns in a given region have on each of edges of the patterns. However, the scope of the present disclosure is not limited to the above examples, and the feature may indicate various geometric features associated with patterns formed in the plurality of semiconductor dies 12 or edges of the patterns.

In an embodiment, the equipment 13 may sample the features of the plurality of semiconductor dies 12. The features of the plurality of semiconductor dies 12 sampled by the equipment 13 may be referred to as “feature values FV”. In an embodiment, the feature values FV may be values expressed by a numerical value.

In an embodiment, the equipment 13 may perform sampling measurement on at least some of the plurality of semiconductor dies 12 on the wafer 11. As a result of performing the sampling measurement, the equipment 13 may acquire the feature values FV of at least some of the plurality of semiconductor dies 12. The feature values FV may respectively correspond to the at least some of the plurality of semiconductor dies 12. For example, the equipment 13 may perform sampling measurement on a first die and a second die included in the plurality of semiconductor dies 12. As a result of performing the sampling measurement, the equipment 13 may acquire a first feature value FV1 of the first die and a second feature value FV2 of the second die on the wafer 11.

The equipment 13 may transmit measurement data MD including the feature values FV to the electronic device 14. For example, the equipment 13 may transmit the measurement data MD including the first feature value FV1 of the first die and the second feature value FV2 of the second die to the electronic device 14. In an embodiment, the measurement data MD may be included in the process data PRCD.

The electronic device 14 may receive the process data PRCD and the measurement data MD from the equipment 13. In an embodiment, the electronic device 14 may receive the process data PRCD and the measurement data MD from an external database. The electronic device 14 may generate feature data FD of the wafer 11 or the plurality of semiconductor dies 12, based on the received process data PRCD and the received measurement data MD. The feature data FD may include the feature values FV of the plurality of semiconductor dies 12.

In an embodiment, the electronic device 14 may generate predicted feature values FV of the semiconductor dies 12 that were not measured by the sampling measurement from among the plurality of semiconductor dies 12. For example, the electronic device 14 may compute the feature values FV of the semiconductor dies 12, on which the sampling measurement is not performed, by using various modules such as a machine learning module and an arithmetic module. The electronic device 14 may generate the feature data FD of the plurality of semiconductor dies 12, based on the feature values FV included in the measurement data MD and the predicted feature values FV.

In an embodiment, the electronic device 14 may generate a wafer map of the wafer 11 based on the feature data FD. For example, the electronic device 14 may generate the wafer map of the wafer 11 based on the measurement data MD and the predicted feature values FV.

The wafer map may correspond to an image including a plurality of pixels. The plurality of pixels may indicate characteristics or features of the plurality of semiconductor dies 12 respectively measured by the electronic device 14 in shade. The pixel may be referred to as a “shot”. For example, the electronic device 14 may indicate the feature values FV of at least some of the plurality of semiconductor dies 12 in shade. The feature value FV of a semiconductor die of a relatively dark pixel may be different from the feature value FV of a semiconductor die of a relatively bright pixel. The feature values FV of semiconductor dies of pixels with similar shading levels may be similar to each other. The wafer map may include or represent a plurality of feature values FV mapped on locations of the plurality of the semiconductor dies 12 on the wafer 11. In some cases, a group of the plurality of pixels of the wafer map may be used to represent the size of each of the plurality of semiconductor dies 12 of the wafer 11.

In an embodiment, the electronic device 14 may predict feature values FV of a plurality of semiconductor dies on a plurality of wafers 11. For example, based on the process data PRCD of processes applied to the plurality of wafers 11 and the measurement data MD including the feature values FV of at least some of the plurality of semiconductor dies on the plurality of wafers 11, the electronic device 14 may generate the predicted feature values of the remaining semiconductor dies of the plurality of semiconductor dies 12. The electronic device 14 may generate the feature data FD of the plurality of wafers 11 or the plurality of semiconductor dies 12 based on the feature values FV included in the measurement data MD and the predicted feature values FV.

As described above, the electronic device 14 may generate predicted feature values FV of the semiconductor dies 12 that are not sampled during the sampling measurement among the plurality of semiconductor dies 12 based on the process data PRCD and the measurement data MD of at least some of the plurality of semiconductor dies 12 that are sampled during the sampling measurement. In some cases, the process data PRCD and the measurement data MD of at least some of the plurality of semiconductor dies 12 may be obtained from an external database. In some cases, the electronic device 14 may generate the full-die level information about the plurality of semiconductor dies 12 based on the process data PRCD and the measurement data MD of at least some of the plurality of semiconductor dies 12 and the predicted feature values FV.

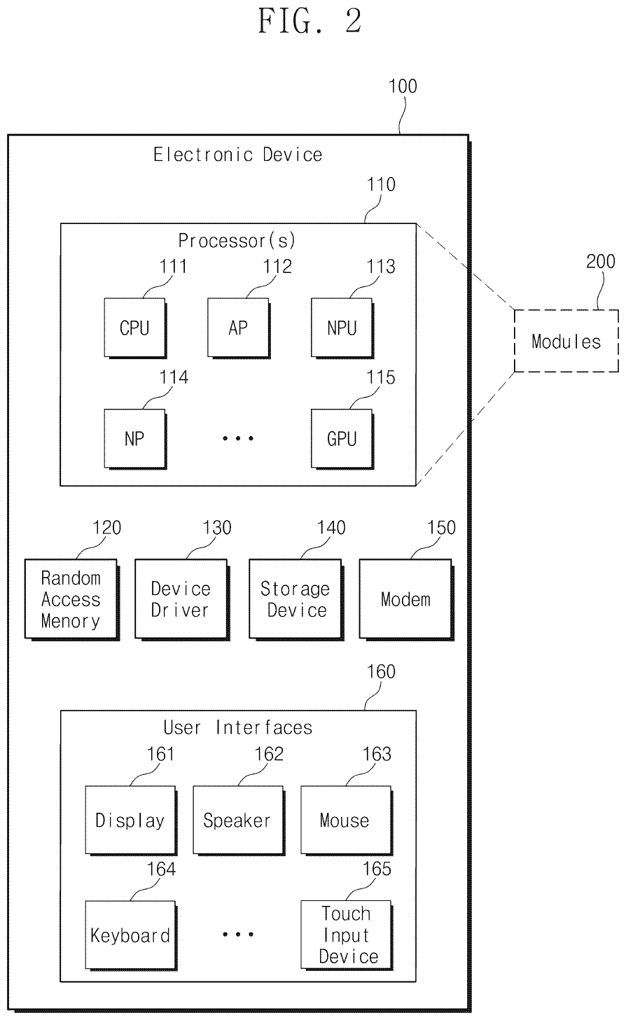

FIG. 2 illustrates an electronic device according to an embodiment of the present disclosure. An electronic device 100 of FIG. 2 may be an example of, or includes aspects of, the electronic device 14 of FIG. 1. Referring of the FIG. 2, the electronic device 100 may be configured to support the manufacture of semiconductor devices. The electronic device 100 may include processors 110, a random access memory 120, a device driver 130, a storage device 140, a modem 150, and user interfaces 160.

The processors 110 may include, for example, at least one general-purpose processor such as a central processing unit (CPU) 111 or an application processor (AP) 112. In some aspects, the processors 110 may further include at least one special-purpose processor such as a neural processing unit (NPU) 113, a neuromorphic processor (NP) 114, or a graphics processing unit (GPU) 115. The processors 110 may include two or more homogeneous processors.

At least one of the processors 110 may execute modules 200. For example, at least some of the modules 200 may include a machine learning module a deep learning module, and at least the remaining ones of the modules 200 may include an operating module based on a given algorithm. In an embodiment, the modules 200 may operate based on at least one of various algorithms such as regression, linear regression, and random forest.

At least one of the processors 110 may be used to train the modules 200 (e.g., a machine learning module among the modules 200) or may be used to execute the trained modules 200. At least one of the processors 110 may train or execute the modules 200 based on a variety of data or information. For example, the modules 200 may be implemented in the form of instructions (or codes) which are executed by at least one of the processors 110. For example, the at least one processor may load the instructions (or codes) of the modules 200 to the random access memory 120.

A machine learning module is a computational algorithm, model, or system designed to recognize patterns, make predictions, or perform a specific task (for example, image processing) without being explicitly programmed. According to some aspects, the machine learning module is implemented as software stored in a memory unit (e.g., the storage device 140) and executable by a processor unit (e.g., the processor(s) 110), as firmware, as one or more hardware circuits, or as a combination thereof.

In one aspect, machine learning module includes machine learning parameters. Machine learning parameters, also known as model parameters or weights, are variables that provide behaviors and characteristics of the machine learning module. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that allow the machine learning module to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, the machine learning module includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of its elements) is added to the embedded representation (n-dimensional vector) of each word. In some examples, a transformer network includes an attention mechanism, where the attention looks at an input sequence and decides at each step which other parts of the sequence are important.

The attention mechanism involves a query, keys, and values denoted by Q, K, and V, respectively. Q is a matrix that contains the query (vector representation of one word in the sequence), K are the keys (vector representations of the words in the sequence) and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

In an example, at least one processor among the processors 110 may be manufactured and used to implement the modules 200. For example, the at least one processor may be a dedicated hardware processor implemented based on the modules 200, which is generated through the learning process of the modules 200.

In an example, at least one processor among the processors 110 may be manufactured and used to implement various machine learning modules or deep learning modules. The at least one processor may implement the modules 200 by receiving information (e.g., instructions or codes) corresponding to the modules 200.

In an example, at least one processor of the processors 110 may be manufactured and used to implement various arithmetic modules. For example, the at least one processor may be manufactured to implement an arithmetic module for performing various computation operations such as an interpolation operation and an extrapolation operation.

The random access memory 120 may be used as a working memory of the processors 110 and may be used as a main memory or a system memory of the electronic device 100. The random access memory 120 may include a volatile memory such as a dynamic random access memory or a static random access memory. In some aspects, the random access memory 120 may include a nonvolatile memory such as a phase-change random access memory, a ferroelectric random access memory, a magnetic random access memory, or a resistive random access memory.

The device driver 130 may control the peripheral devices based on a request of the processors 110. For example the peripheral device includes the storage device 140, the modem 150, and the user interfaces 160. The storage device 140 may include a stationary storage device such as a hard disk drive or a solid state drive. In some aspects, the storage device 140 may include a removable storage device such as an external hard disk drive, an external solid state drive, or a removable memory card.

The modem 150 may provide remote communication with the external device. The modem 150 may perform wired or wireless communication with the external device. The modem 150 may communicate with the external device based on at least one of various communication schemes such as Ethernet, wireless-fidelity (Wi-Fi), long term evolution (LTE), and 5th generation (5G) mobile communication.

The user interfaces 160 may receive information from the user and may provide and/or display information to the user. The user interfaces 160 may include at least one user output interface such as a display 161 or a speaker 162, and at least one user input interface such as a mouse 163, a keyboard 164, or a touch input device 165.

The instructions (or codes) of the modules 200 may be received through the modem 150 and may be stored in the storage device 140. The instructions (or codes) of the modules 200 may be stored in a removable storage device, and the removable storage device may be connected to the electronic device 100. The instructions (or codes) of the modules 200 may be loaded to the random access memory 120 from the storage device 140 so as to be executed.

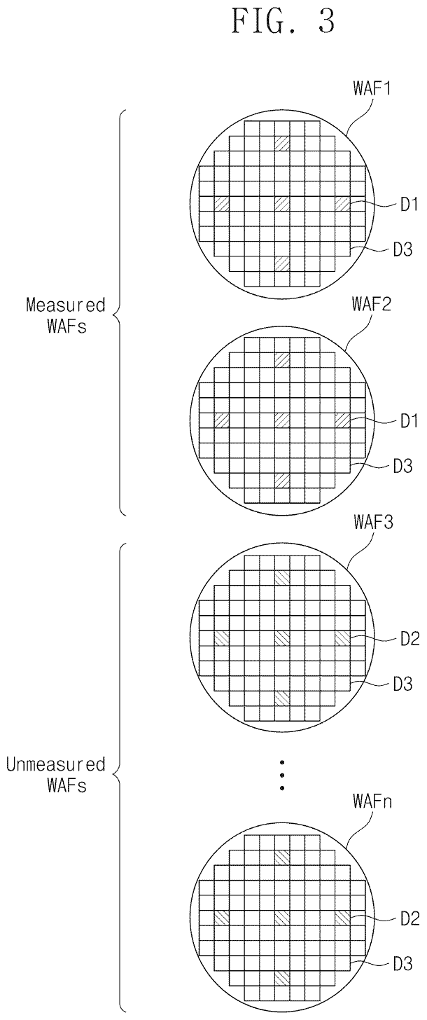

FIG. 3 illustrating an example of a plurality of wafers in which a plurality of semiconductor dies are manufactured according to an embodiment of the present disclosure. Referring to FIGS. 2 and 3, a plurality of wafers may include measured wafers WAF1 and WAF2 and unmeasured wafers WAF3 to WAFn. The measured wafers WAF1 and WAF2 may indicate wafers on which the sampling measurement is performed. The unmeasured wafers WAF3 to WAFn may indicate wafers on which the sampling measurement is not performed.

In an embodiment, one lot may include the plurality of wafers WAF1 to WAFn. The same semiconductor manufacturing process may be performed on the one lot including the plurality of wafers WAF1 to WAFn.

In an embodiment, the plurality of wafers WAF1 to WAFn may be included in different lots on which the same process is performed. For example, at least some of the plurality of wafers WAF1 to WAFn may be included in a first lot, and the remaining wafers may be included in a second lot. For example, the same process may be performed on (or applied to) the first lot and the second lot.

Each of the plurality of wafers WAF1 to WAFn may include reference dies and the remaining dies. In an embodiment, the reference dies may indicate dies targeted for sampling measurement. The reference dies of each of the plurality of wafers WAF1 to WAFn may correspond to the same coordinates on a wafer. The remaining dies may indicate dies among the plurality of semiconductor dies other than the reference dies. For example, the remaining dies may indicate dies that are not targeted for sampling measurement among the plurality of semiconductor dies. The reference dies may be classified based on whether the sampling measurement is performed. For example, the reference dies may be classified into dies on which the sampling measurement is performed and dies on which the sampling measurement is not performed.

In FIG. 3, first dies D1 may indicate dies on which the sampling measurement is performed among dies of the measured wafers WAF1 and WAF2. For example, the first dies D1 may indicate dies, on which the sampling measurement is performed, from among dies targeted for sampling measurement.

The second dies D2 may indicate reference dies on the unmeasured wafers WAF3 to WAFn. For example, the second dies D2 may indicate dies, on which the sampling measurement is not performed, from among dies targeted for sampling measurement. In some cases, the second dies D2 and the first dies D1 may be at a same location of the plurality of wafers WAF1 to WAFn.

Third dies D3 may indicate the remaining dies other than the first dies D1 and the second dies D2 among a plurality of dies manufactured in the plurality of wafers WAF1 to WAFn. For example, the third dies D3 may indicate the remaining dies of each of the plurality of wafers WAF1 to WAFn.

The electronic device 100 may receive the process data PRCD associated with a process performed in the plurality of wafers WAF1 to WAFn and the measurement data MD. The measurement data MD may include the measured feature values FV of the first dies D1. For example, the measurement data MD may be associated with features of the first dies D1.

The electronic device 100 may generate first prediction data PD1 associated with features of the second dies D2 based on the measurement data MD of the first dies D1 and the process data PRCD associated with the process performed in the plurality of wafers WAF1 to WAFn. For example, the electronic device 100 may include a machine learning module trained to generate the first prediction data PD1 associated with the features of the second dies D2 based on the measurement data MD of the first dies D1 and the process data PRCD. The first prediction data PD1 may include the feature values FV of the second dies D2.

The electronic device 100 may compute second prediction data PD2 associated with the third dies D3 based on the measurement data MD and the first prediction data PD1. For example, the electronic device 100 may include an arithmetic module trained to generate the second prediction data PD2 associated with the third dies D3 based on the measurement data MD and the first prediction data PD1. The second prediction data PD2 may include the feature values FV of the third dies D3. By using the arithmetic module, the electronic device 100 may reduce the amount of computation to generate the second prediction data PD2.

In an embodiment, the electronic device 100 may generate the second prediction data PD2 associated with the third dies D3 based on at least one of the process data PRCD, the measurement data MD, and the first prediction data PD1 by using the machine learning module. For example, the measurement data MD may include the measured feature values FV of at least some of the third dies D3.

In FIG. 3, the plurality of wafers WAF1 to WAFn are illustrated as including the measured wafers WAF1 and WAF2 and the unmeasured wafers WAF3 to WAFn, but the scope of the present disclosure is not limited thereto. For example, the one lot may include at least one measured wafer and at least one unmeasured wafer.

In FIG. 3, an example in which the number of reference dies included in each of the plurality of wafers WAF1 to WAFn is five is illustrated, but the scope of the present disclosure is not limited thereto. For example, the number of reference dies of each of the plurality of wafers WAF1 to WAFn may be predetermined.

In an embodiment, a wafer on which the sampling measurement is performed may vary for each process. For example, after the first process is performed, the sampling measurement may be performed on the first wafer WAF1 and the second wafer WAF2. After the second process following the first process is performed, the sampling measurement may be performed on the third wafer WAF3 and the fourth wafer WAF4.

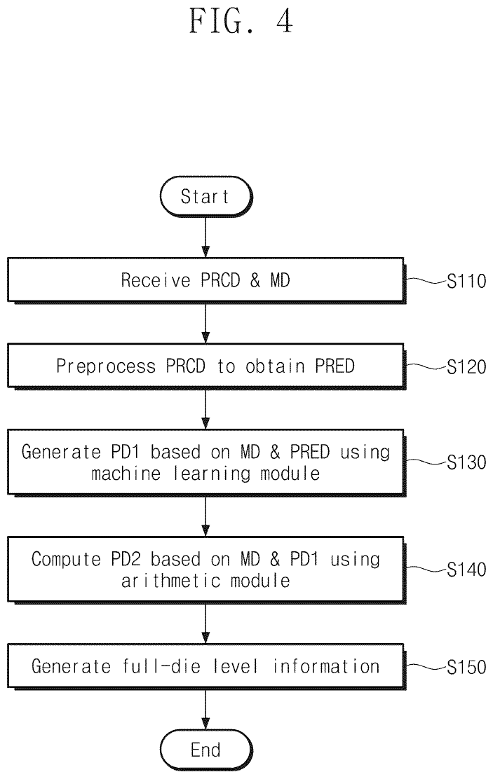

FIG. 4 illustrates an example of an operating method of an electronic device according to an embodiment of the present disclosure. Referring to FIGS. 2 to 4, in operation S110, the electronic device 100 may receive the process data PRCD and the measurement data MD. The process data PRCD may be associated with at least one process applied to (or performed in) the plurality of wafers WAF1 to WAFn, and the measurement data MD may include the measured feature values FV of the first dies D1.

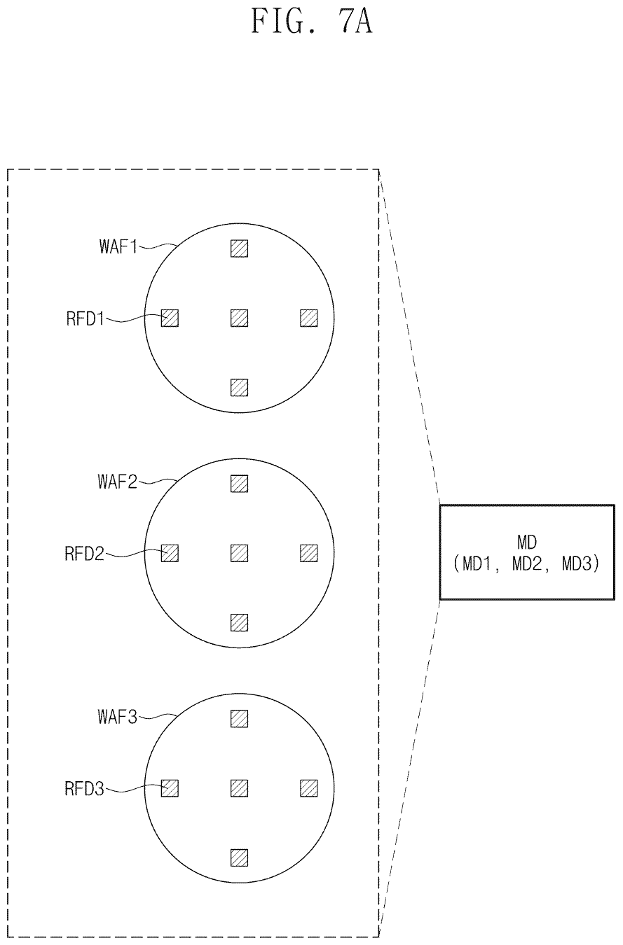

In operation S120, the electronic device 100 may preprocess the process data PRCD to obtain preprocessed data PRED. Further detail on the preprocessing operation of the electronic device 100 is described with reference to FIG. 6. In operation S130, the electronic device 100 may generate the first prediction data PD1 associated with features of the second dies D2 based on the measurement data MD and the preprocessed data PRED by using the machine learning module. The first prediction data PD1 may include the feature values FV of the second dies D2.

In an embodiment, the machine learning module may operate based on an ensemble algorithm which includes a plurality of boosting models. Further detail on operation of the electronic device 100 using the machine learning model is described with reference to 7A and 7B.

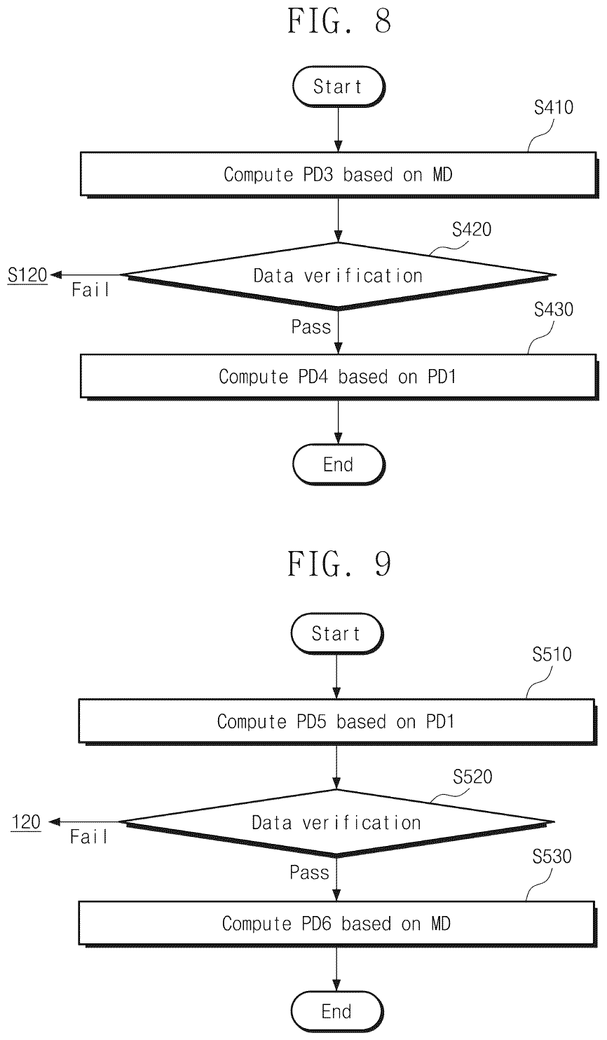

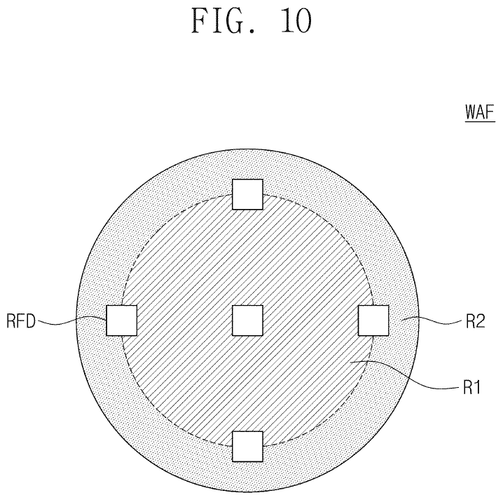

In operation S140, the electronic device 100 may compute the second prediction data PD2 associated with features of the third dies D3 based on the measurement data MD and the first prediction data PD1 by using the arithmetic module. For example, the electronic device 100 may compute the second prediction data PD2 associated with features of the third dies D3 based on the interpolation operation and the extrapolation operation on the measurement data MD and the first prediction data PD1. The second prediction data PD2 may include the feature values FV of the third dies D3. Further detail on the computation operation of the electronic device 100 is described with reference to FIGS. 8 and 9.

In operation S150, the electronic device 100 may generate full-die level information about a plurality of semiconductor dies manufactured in the plurality of wafers WAF1 to WAFn based on the measurement data MD, the first prediction data PD1, and the second prediction data PD2. For example, the electronic device 100 may obtain the feature data FD including the feature values FV of the plurality of semiconductor dies manufactured in the plurality of wafers WAF1 to WAFn based on the measurement data MD, the first prediction data PD1, and the second prediction data PD2.

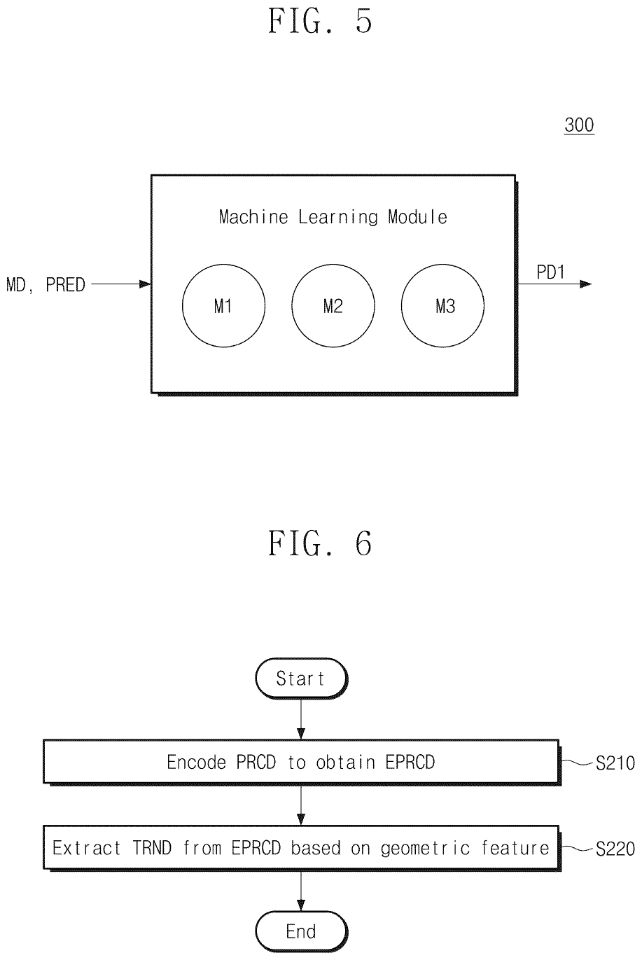

FIG. 5 illustrates an example of an operation of a machine learning module according to an embodiment of the present disclosure. Referring to FIGS. 2 to 5, a machine learning module 300 may generate the first prediction data PD1 based on the measurement data MD and the preprocessed data PRED. The machine learning module 300 may operate based on an ensemble algorithm which includes a first boosting model M1, a second boosting model M2, and a third boosting model M3. However, the scope of the present disclosure is not limited thereto. For example, the machine learning module 300 may generate the first prediction data PD1 based on various algorithms.

Boosting model is a type of machine learning ensemble model that combines multiple weak learners, typically simple models like decision trees, to create a stronger predictive model. Boosting model works sequentially, where each new model focuses on correcting the errors made by the previous ones, often by assigning higher weights to misclassified data points. The output prediction is generated by aggregating the outputs of all models through a weighted vote or average. In some cases, the boosting model may include boosting algorithms such as AdaBoost, Gradient Boosting Machines (GBM), XGBoost, LightGBM, and CatBoost.

The machine learning module 300 may receive the measurement data MD and the preprocessed data PRED. The measurement data MD may include the feature values FV of the first dies D1. For example, the measurement data MD may include the feature values FV of the reference dies of the measured wafers WAF1 and WAF2.

The machine learning module 300 may be trained or fine-tuned based on the measurement data MD and the preprocessed data PRED. After the machine learning module 300 is trained or fine-tuned, the machine learning module 300 may generate the feature values FV of the second dies D2 by using the first to third boosting models M1 to M3.

In an embodiment, the machine learning module 300 may generate the feature values FV of the second dies D2 of the unmeasured wafers WAF3 to WAFn corresponding to the coordinates of the first dies D1 of the measured wafers WAF1 and WAF2. For example, the machine learning module 300 may generate the feature values FV of the second dies D2 corresponding to the first coordinates based on the feature values FV of the first dies D1 corresponding to the first coordinates. In some embodiments, the machine learning module 300 may generate the feature values FV of the second dies D2 corresponding to the second coordinates based on the feature values FV of the first dies D1 corresponding to the second coordinates. For example, the machine learning module 300 may generate the feature values FV of the second dies D2 for each coordinates in the unmeasured wafers WAF3 to WAFn.

In an embodiment, the machine learning module 300 may compute final feature values FV of the second dies D2 by averaging the feature values FV of the second dies D2 generated from each of the first to third boosting models M1 to M3.

For example, when generating the feature values FV of the second dies D2 in the unmeasured wafers WAF3 to WAFn corresponding to the first coordinates, each of the first to third boosting models M1 to M3 may generate the feature values FV of the second dies D2 corresponding to the first coordinates based on the feature values FV of the first dies D1 of the measured wafers WAF1 and WAF2 corresponding to the first coordinates. The machine learning module 300 may determine the final feature values FV of the second dies D2 corresponding to the first coordinates by averaging the feature values FV generated from each of the first to third boosting models M1 to M3. In some embodiments, each of the feature values FV generated by the first to third boosting models M1 to M3 may be generated simultaneously or sequentially.

In an embodiment, the processors 110 may update the machine learning module 300. For example, the processors 110 may train the machine learning module 300 based on the first prediction data PD1.

In an embodiment, when at least one of inputs including the measurement data MD and the preprocessed data PRED is changed, the machine learning module 300 may be fine-tuned and generate new predictions. For example, when the feature values FV included in the measurement data MD are changed, the machine learning module 300 may be fine-tuned based on the changed measurement data MD (or changed parameters). After fine-tuning the machine learning module 300, the machine learning module 300 may generate the first prediction data PD1. For example, the first prediction data PD1 may be used to fine-tune (or update parameters of) the machine learning module 300.

FIG. 6 illustrates an example of a preprocessing operation of an electronic device according to an embodiment of the present disclosure. Operations of FIG. 6 may correspond to operation S120 of FIG. 4.

Referring to FIGS. 2 to 4 and 6, in operation S210, the electronic device 100 may encode the process data PRCD to obtain encoded process data EPRCD. For example, the electronic device 100 may perform encoding on the process data PRCD such that text data TD included in the process data PRCD is converted into numerical data ND.

In some embodiments, the electronic device 100 may include a text encoder configured to encode the process data PRCD (e.g., text data) to obtain encoded process data EPRCD (e.g., numerical data). The text encoder may be a computational algorithm that transforms data from one format, domain, or representation into another format for the computer processing. In some cases, the encoder reduces the dimensionality or size of data while preserving key information in the data.

In an embodiment, the process data PRCD may include at least one text data TD. For example, the process data PRCD may include the text data TD such as equipment data associated with a process, recipe data associated with a process, and reticle data associated with a process. The electronic device 100 may encode the process data PRCD such that the text data TD included in the process data PRCD are used for training and inferencing a machine learning module.

In an embodiment, the electronic device 100 may obtain the encoded process data EPRCD by encoding at least partial data of the process data PRCD. In an embodiment, the electronic device 100 may obtain the encoded process data EPRCD by encoding data associated with a geometric feature targeted for measurement from among the process data PRCD.

In operation S220, the electronic device 100 may extract training data TRND from the encoded process data EPRCD based on the geometric feature. For example, the electronic device 100 may extract the training data TRND from the encoded process data EPRCD based on the geometric feature targeted for measurement. For example, the electronic device 100 may extract data, which are associated with the geometric feature targeted for measurement, from the encoded process data EPRCD.

In an embodiment, the operation in which the electronic device 100 extracts the training data TRND may include an operation of selecting data, which have high correlation with the geometric feature targeted for measurement, from the encoded process data EPRCD. For example, the electronic device 100 may align or rank a plurality of data included in the encoded process data EPRCD based on the geometric feature targeted for measurement. The electronic device 100 may select a portion of the data from the aligned or ranked data.

In an embodiment, the operation in which the electronic device 100 generates the training data TRND may include an operation of removing the noise of the encoded process data EPRCD. In an embodiment, the operation in which the electronic device 100 generates the training data TRND may be performed based on a linear regression algorithm. In an embodiment, the operation in which the electronic device 100 generates the training data TRND may be performed based on the standard deviation of the plurality of data included in the encoded process data EPRCD. However, the scope of the present disclosure is not limited thereto. For example, the electronic device 100 may generate the training data TRND through various methods of removing the noise of the encoded process data EPRCD.

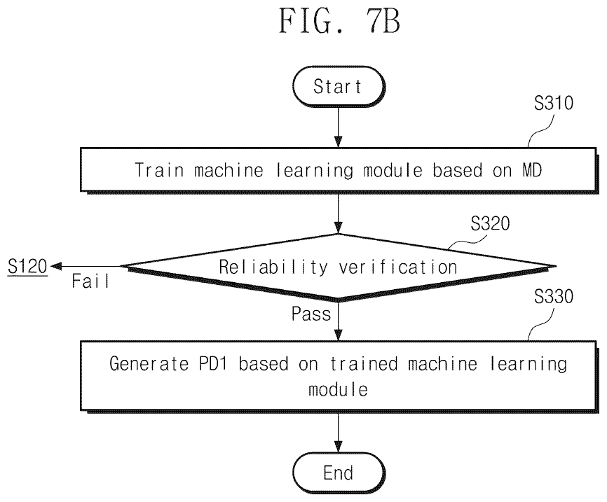

FIGS. 7A and 7B illustrates an example in which an electronic device is trained and performs inferencing according to embodiment of the present disclosure. Operations of FIG. 7B may correspond to operation S130 of FIG. 4. In FIGS. 7A and 7B, the example shown illustrates that the first to third wafers WAF1 to WAF3 are measured wafers.

Referring to FIG. 7A, the measurement data MD may include first measurement data MD1, second measurement data MD2, and third measurement data MD3. The first measurement data MD1 may include the feature values FV of reference dies (hereinafter referred to as “first reference dies RFD1”) of the first wafer WAF1. The second measurement data MD2 may include the feature values FV of reference dies (hereinafter referred to as “second reference dies RFD2”) of the second wafer WAF2. The third measurement data MD3 may include the feature values FV of reference dies (hereinafter referred to as “third reference dies RFD3”) of the third wafer WAF3.

Referring to FIGS. 2, 5, 7A, and 7B, in operation S310, the electronic device 100 may train a machine learning module based on the first measurement data MD1 and the second measurement data MD2 included in the measurement data MD. For example, the first measurement data MD1 and the second measurement data MD2 included in the measurement data MD may be used to initialize the machine learning module. In some cases, the first measurement data MD1 and the second measurement data MD2 included in the measurement data MD may be used to fine-tune the machine learning module.

In operation S320, the electronic device 100 may perform a reliability verification operation on the trained machine learning module. For example, the electronic device 100 may generate verification data VD (e.g., third prediction data PD3) including the feature values FV of the third reference die RFD3 by using the trained machine learning module. For example, the electronic device 100 may generate predicted feature values FV of the third reference die RFD3 by using the trained machine learning module.

The electronic device 100 may compare the third measurement data MD3 and third prediction data PD3. For example, the electronic device 100 may compare the measured feature values FV (or ground-truth feature value FV) included in the third measurement data MD3 and the predicted feature values FV included in the verification data VD. When a result of the comparison operation indicates “PASS”, the electronic device 100 may determine that a result of the reliability verification operation corresponds to “PASS” and may perform operation S330. When a result of the comparison operation indicates “FAIL”, the electronic device 100 may repeat operation S120 of FIG. 2. For example the electronic device 100 may change a preprocessing parameter (e.g., the number of training data TRND to be extracted) and may repeat operation S120.

In an embodiment, when an error between the feature values FV included in the third measurement data MD3 and the feature values FV included in the verification data VD is within a threshold error, the electronic device 100 may determine that a result of the comparison operation corresponds to “PASS”. For example, when the difference between the feature values FV included in the third measurement data MD3 and the feature values FV included in the verification data VD is within a predetermined range, the electronic device 100 may indicate a result of the corresponding to “PASS”.

In operation S330, the electronic device 100 may generate the first prediction data PD1 associated with the second dies D2 by using the trained machine learning module. For example, the electronic device 100 may generate the first prediction data PD1 associated with features of the second dies D2 (of the unmeasured wafers at the same coordinate) based on the first measurement data MD1 and the second measurement data MD2. The first prediction data PD1 may include the feature values FV of the second dies D2.

FIG. 8 illustrates an example in which an electronic device performs computation according to an embodiment of the present disclosure. Operations of FIG. 8 may correspond to operation S140 of FIG. 4.

In FIG. 8, the first dies D1 represent reference dies of at least one measured wafer, the second dies D2 represent reference dies of at least one unmeasured wafer at the same coordinate as the first dies D1, and the third dies D3 include the remaining dies (hereinafter referred to as “first remaining dies”) of at least one measured wafer and the remaining dies (hereinafter referred to as “second remaining dies”) of at least one unmeasured wafer. Also, in FIG. 8, the process data PRCD include wafer measurement data WMD including the measured feature values FV of the first dies D1 and the first remaining dies.

Referring to FIGS. 2 and 8, in operation S410, the electronic device 100 may compute the third prediction data PD3 including the feature values FV of the first remaining dies based on the measurement data MD associated with the first dies D1 by using the arithmetic module. For example, the electronic device 100 may predict the feature values FV of the first remaining dies by using the arithmetic module.

In operation S420, the electronic device 100 may perform a data verification operation on at least one measured wafer, based on the wafer measurement data WMD and the third prediction data PD3. For example, the electronic device 100 may compare the wafer measurement data WMD and the third prediction data PD3. In an embodiment, the electronic device 100 may compare the measured feature values FV of the first remaining dies included in the wafer measurement data WMD and the predicted feature values FV of the first remaining dies included in the third prediction data PD3, respectively.

When a result of the comparison operation indicates “PASS”, the electronic device 100 may determine that a result of the data verification operation corresponds to “PASS” and may perform operation S430. When a result of the comparison operation indicates “FAIL”, the electronic device 100 may repeat operation S120 of FIG. 2. For example the electronic device 100 may change a preprocessing parameter (e.g., the number of training data TRND to be extracted) and may repeat operation S120.

In an embodiment, when an error between the feature values FV included in the third prediction data PD3 and the feature values FV included in the wafer measurement data WMD is within a threshold error, the electronic device 100 may determine that a result of the comparison operation corresponds to “PASS”. For example, when the difference between the feature values FV included in the third prediction data MP3 and the feature values FV included in the wafer measurement data WMD is within a predetermined range, the electronic device 100 may indicate a result of the corresponding to “PASS”.

In operation S430, the electronic device 100 may compute fourth prediction data PD4 including the feature values FV of the second remaining dies based on the first prediction data PD1 associated with the second dies D2 by using the arithmetic module. For example, the electronic device 100 may generate predicted feature values FV of the second remaining dies by using the arithmetic module.

In some aspects, the arithmetic module is a software or a computer algorithm configured to perform mathematical operations like addition, subtraction, multiplication, division, and sometimes advanced tasks like modular arithmetic or floating-point computations. In some cases, the arithmetic module is configured to perform interpolation and extrapolation operations.

FIG. 9 illustrates an example in which an electronic device performs computation according to an embodiment of the present disclosure. Operations of FIG. 9 may correspond to operation S140 of FIG. 4.

In FIG. 9, the first dies D1 represent reference dies of at least one measured wafer, the second dies D2 represent reference dies of at least one unmeasured wafer at the same coordinate as the first dies D1, and the third dies D3 include the first remaining dies of at least one measured wafer and the second remaining dies of at least one unmeasured wafer. Also, in FIG. 9, the process data PRCD include the wafer measurement data WMD including the measured feature values FV of the second dies D2 and the second remaining dies.

Referring to FIGS. 2 and 9, in operation S510, the electronic device 100 may compute fifth prediction data PD5 including the feature values FV of the second remaining dies based on the first prediction data PD1 associated with the second dies D2 by using the arithmetic module. For example, the electronic device 100 may predict the feature values FV of the second remaining dies by using the arithmetic module.

In operation S520, the electronic device 100 may perform a data verification operation on at least one unmeasured wafer based on the wafer measurement data WMD, the first prediction data PD1, and the fifth prediction data PD5. For example, the electronic device 100 may compare the wafer measurement data WMD with the first prediction data PD1 and the fifth prediction data PD5. In an embodiment, the electronic device 100 may compare the measured feature values FV of the first dies D1 included in the wafer measurement data WMD and the predicted feature values FV of the first dies D1 included in the first prediction data PD1, respectively. In some cases, the electronic device 100 may compare the measured feature values FV of the second remaining dies included in the wafer measurement data WMD and the predicted feature values FV of the second remaining dies included in the fifth prediction data PD5, respectively.

When a result of the comparison operation indicates “PASS”, the electronic device 100 may determine that a result of the data verification operation corresponds to “PASS” and may perform operation S530. When a result of the comparison operation indicates “FAIL”, the electronic device 100 may repeat operation S120 of FIG. 2. For example the electronic device 100 may change a preprocessing parameter (e.g., the number of training data TRND to be inferred) and may repeat operation S120.

In an embodiment, when an error between the feature values FV included in the first prediction data PD1 and the fifth prediction data PD5 and the feature values FV included in the wafer measurement data WMD is within a threshold error, the electronic device 100 may determine that a result of the comparison operation corresponds to “PASS”. For example, when the difference between the feature values FV in the first prediction data PD1 and the fifth prediction data PD5 and the feature values FV included in the wafer measurement data WMD is within a predetermined range, the electronic device 100 may indicate a result of the corresponding to “PASS”.

In operation S530, the electronic device 100 may compute sixth prediction data PD6 including the feature values FV of the first remaining dies based on the measurement data MD associated with the first dies D1 by using the arithmetic module. For example, the electronic device 100 may predict the feature values FV of the first remaining dies by using the arithmetic module.

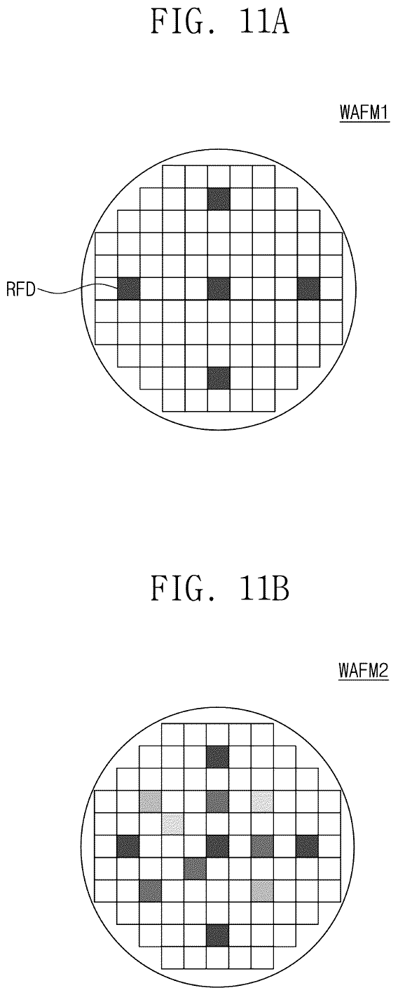

FIG. 10 illustrates an example in which an electronic device performs computation on a wafer according to an embodiment of the present disclosure. In FIG. 10, the wafer WAF is an unmeasured wafer and includes reference dies RFD and the remaining dies. In FIG. 10, the remaining dies include first region dies included in a first region R1 and second region dies included in a second region R2. For convenience of description, the wafer WAF and the reference dies RFD are illustrated in FIG. 10. Also, in FIG. 10, the first prediction data PD1 including the predicted feature values FV of the reference dies RFD is provided.

In one aspect, the first region R1 is a region on the wafer WAF that encompasses the reference dies. For example, in FIG. 10, five reference dies are illustrated, where the region (or circular region) encompassing the five reference dies represents the first region. In one aspect, the second region R2 is the remaining region between the outer circumference of the first region R1 and the circumference of the wafer WAF. In some cases, the shape of the first region R1 and second region R2 are not necessarily limited to the shape shown in the example in FIG. 10. For example, the first region R1 and the second region R2 may include polygon shapes.

Referring to FIGS. 2 and 10, the electronic device 100 may compute the second prediction data PD2 based on the first prediction data PD1 by using the arithmetic module. The second prediction data PD2 may include first region data associated with the first region dies and second region data associated with the second region dies. For example, the electronic device 100 may perform the interpolation operation and the extrapolation operation and may compute the second prediction data PD2 based on the first prediction data PD1.

In an embodiment, the electronic device 100 may sequentially perform the interpolation operation and the extrapolation operation. For example, to generated the predicted feature values FV of the first region dies, the electronic device 100 may perform the interpolation operation based on the first prediction data PD1. As a result of performing the interpolation operation, the electronic device 100 may acquire the first region data including the predicted feature values FV of the first region dies. Then, to generate the predicted feature values FV of the second region dies, the electronic device 100 may perform the extrapolation operation based on the first region data and the first prediction data PD1. As a result of performing the extrapolation operation, the electronic device 100 may generate the second region data including the predicted feature values FV of the second region dies. As described above, the electronic device 100 may perform the interpolation operation and the extrapolation operation and may compute the second prediction data PD2 including the second region data.

In an embodiment, the electronic device 100 may repeatedly perform the interpolation operation to acquire the first region data. For example, the electronic device 100 may perform the interpolation operation and may predict the feature values FV of at least some of the first region dies. Afterwards, to predict the feature values FV of the remaining ones of the first region dies, the electronic device 100 may perform the interpolation operation based on the predicted feature values FV of the reference dies and at least some of the first region dies.

In an embodiment, the electronic device 100 may repeatedly perform the extrapolation operation to acquire the second region data. For example, the electronic device 100 may perform the extrapolation operation and may predict the feature values FV of at least some of the second region dies. Afterwards, to predict the feature values FV of the remaining ones of the second region dies, the electronic device 100 may perform the extrapolation operation based on the predicted feature values FV of the first region dies, the reference dies, and at least some of the second region dies. For example at least some of the second region dies may indicate dies relatively close to the center of the wafer WAF from among the second region dies, and the others of the second region dies may indicate dies relatively distant from the center of the wafer WAF from among the second region dies.

In an embodiment, the electronic device 100 may simultaneously perform the interpolation operation and the extrapolation operation. For example, to predict the feature values FV of at least some of the first region dies, the electronic device 100 may perform the interpolation operation based on the first prediction data PD1. At the same time, to predict the feature values FV of at least some of the second region dies, the electronic device 100 may perform the extrapolation operation based on the first prediction data PD1. To generate the predicted feature values FV of the remaining ones of the first region dies and the remaining ones of the second region dies, the electronic device 100 may repeatedly perform the interpolation operation and the extrapolation operation based on the first prediction data PD1 and the predicted feature values FV.

In an embodiment, the electronic device 100 may perform at least one of the interpolation operation and the extrapolation operation based on influences of neighboring dies. For example, the electronic device 100 may perform at least one of the interpolation operation and the extrapolation operation based on influences (e.g., a distance or a vector) of neighboring patterns of the neighboring dies. In some cases, the electronic device 100 determines the number of iterations for performing the interpolation operation and/or the extrapolation operation. In some cases, the number of the predicted feature values FV of first region dies and/or second region dies may be determined based on the number of iterations.

In FIG. 10, the description is given based on the unmeasured wafer, but the same or similar computation may be applied to a measured wafer. For example, when the wafer WAF is a measured wafer, the electronic device 100 may perform at least one of the interpolation operation and the extrapolation operation based on the measurement data MD including the measured feature values FV of the reference dies RFD. The electronic device 100 may compute the second prediction data PD2 associated with the remaining dies by iteratively performing at least one of the interpolation operation and the extrapolation operation.

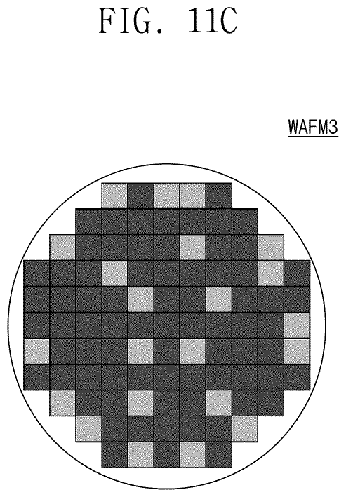

FIGS. 11A to 11C illustrate examples of results of computation which an electronic device performs on a wafer of FIG. 10. Wafer maps WAFM1 to WAFM3 whose resolution is improved as at least one of the interpolation operation and the extrapolation operation is repeated are illustrated in FIGS. 11A to 11C.

Referring to FIGS. 2, 10, and 11A to 11C, the electronic device 100 may generate the wafer maps WAFM1 to WAFM3 of the wafer WAF. The wafer maps WAFM1 to WAFM3 may include the pixels corresponding to the feature values FV of semiconductor dies. In an embodiment, the wafer maps WAFM1 to WAFM3 may include information about semiconductor dies manufactured on the wafer WAF. For example, the wafer maps WAFM1 to WAFM3 may include information about the height of each of the semiconductor dies manufactured on the wafer WAF, a distribution of the semiconductor dies, etc.

FIG. 11A illustrate the first wafer map WAFM1 of the wafer WAF which is generated before the performance of interpolation operation or the extrapolation operation. In FIG. 11A, the first wafer map WAFM1 may include the predicted feature values FV of the reference dies RFD. In an embodiment, when the wafer WAF is an unmeasured wafer, the first wafer map WAFM1 may include the predicted feature values FV of the reference die RFD. In an embodiment, when the wafer WAF is a measured wafer, the first wafer map WAFM1 may include the measured feature values FV of the reference dies RFD. The predicted feature values FV or the measured feature values FV are represented as a darker shade within the wafer WAF.

FIG. 11B shows the second wafer map WAFM2 of the wafer WAF which is generated at an arbitrary point in time while the interpolation operation is performed. In FIG. 11B, the second wafer map WAFM2 may include the feature values FV of the reference dies RFD and the feature values FV of at least some of the remaining dies. For example, the second wafer map WAFM2 may include the predicted feature values FV of the reference dies RFD and the predicted feature values FV of at least some of the first region dies. In some cases, the different shades of the boxes within the wafer WAF may represent the predicted feature values FV of at least some of the first region dies generated at different time steps during the interpolation operation.

FIG. 11C shows the third wafer map WAFM3 of the wafer WAF which is generated at a point in time when the interpolation operation and the extrapolation operation are completely performed. In FIG. 11C, the third wafer map WAFM3 may include the feature values FV of the reference dies RFD and the feature values FV of the remaining dies. For example, the third wafer map WAFM3 may include the predicted feature values FV of the reference dies RFD, the predicted feature values FV of the first region dies, and the predicted feature values FV of the second region dies.

In an embodiment, the electronic device 100 may perform the data verification operation on the wafer WAF based on the third wafer map WAFM3. For example, the electronic device 100 may compare the third wafer map WAFM3 and the wafer measurement data WMD including the measured feature values FV of the semiconductor dies on the wafer WAF. For example the wafer measurement data WMD may be included in the process data PRCD.

The electronic device 100 may repeat at least one of the interpolation operation and the extrapolation operation, and thus, the reliability of the predicted feature values FV of the remaining dies may be improved. For example, the electronic device 100 may repeat at least one of the interpolation operation and the extrapolation operation, and thus, an error between the predicted feature values FV of the remaining dies and the measured feature values FV of the remaining dies may be reduced. It is understood from FIGS. 11A to 11C that the brightness of the pixels corresponding to the remaining dies changes as at least one of the interpolation operation and the extrapolation operation is repeated.

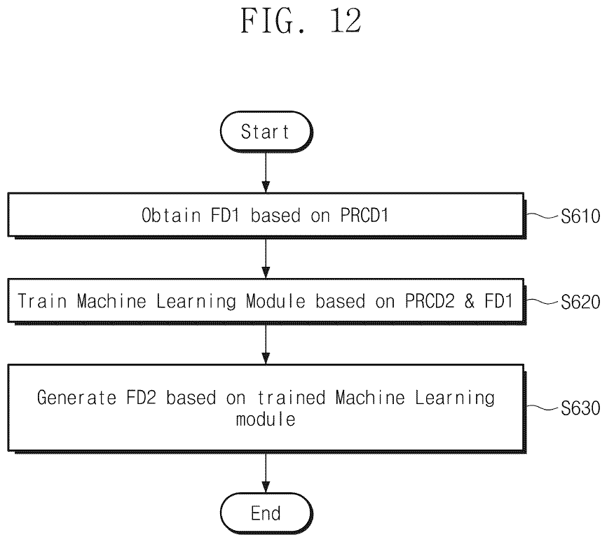

FIG. 12 illustrates an example of an operating method of an electronic device according to an embodiment of the present disclosure. Referring to FIGS. 2 and 12, in operation S610, the electronic device 100 may perform the first process and may then obtain first feature data FD1 of a plurality of semiconductor dies manufactured on a plurality of wafers based on first process data PRCD1. The first feature data FD1 may include full-die level information of the plurality of semiconductor dies on which the first process is performed. The electronic device 100 may perform operation S610 based on the operations of the electronic device 100 described with reference to FIGS. 4 to 10.

In operation S620, after performing a second process following the first process, the electronic device 100 may train the machine learning module based on second process data PRCD2 and the first feature data FD1. The electronic device 100 may perform operation S620 by fine-tuning and perform inference of the electronic device 100 described with reference to FIGS. 5, 7A, and 7B.

In operation S630, the electronic device 100 may generate second feature data FD2 of the plurality of semiconductor dies manufactured on the plurality of wafers based on the trained machine learning module. The second feature data FD2 may include full-die level information of the plurality of semiconductor dies on which the second process is performed. The electronic device 100 may perform operation S610 based on the operations of the electronic device 100 described with reference to FIGS. 4 to 10.

As described above, the electronic device 100 may generate the feature data FD including the full-die level information about the plurality of semiconductor dies whenever a semiconductor process is performed on a wafer(s). In addition, the electronic device 100 may use current feature data FD associated with a current process as the training data TRND of the machine learning module 300 by using previous feature data FD associated with at least one process previously performed.

In the above embodiments, components according to the present disclosure are described by using the terms “first”, “second”, “third”, etc. However, the terms “first”, “second”, “third”, etc. may be used to distinguish components from each other and do not limit the present disclosure. For example, the terms “first”, “second”, “third”, etc. do not involve an order or a numerical meaning of any form.

According to the present disclosure, an electronic device may acquire measurement data of a plurality of wafers and a plurality of semiconductor dies manufactured in the plurality of wafers, based on measurement data of at least some of the plurality of semiconductor dies. Accordingly, costs and a time which are required when the plurality of semiconductor dies are monitored may be reduced.

According to the present disclosure, the electronic device may easily manage the variability between wafers, the variability between lots, and commonality and uniformity between semiconductor dies. Accordingly, an electronic device may support the manufacture of semiconductor dies with improved reliability.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A method supporting manufacture of semiconductor dies, the method comprising:
obtaining, using a processor, process data of the semiconductor dies, wherein the semiconductor dies include first dies, second dies, and third dies;
obtaining, using the processor, measurement data associated with features of the first dies;
encoding the process data to obtain preprocessed process data;
generating, using a machine learning module, first prediction data representing features of the second dies based on the measurement data and the preprocessed process data;
computing, using an arithmetic module, second prediction data representing features of the third dies based on the measurement data and the first prediction data; and
generating, using the processor, full-die level information representing features of the semiconductor dies based on the measurement data, the first prediction data, and the second prediction data.

2. The method of claim 1, wherein:
each of the features of the first dies, the second dies, and the third dies represents a geometric characteristic of patterns formed during a manufacturing process of the semiconductor dies or edges of the patterns.

3. The method of claim 1, wherein generating the first prediction data further comprises:
initializing parameters of the machine learning module based on the measurement data;
generating a verification result by performing a reliability verification operation on the machine learning module; and
generating the first prediction data based on the verification result.

4. The method of claim 3, further comprising:
obtaining first measurement data of first reference dies on a first wafer, second measurement data of second reference dies on a second wafer, and third measurement data of third reference dies on a third wafer;
initializing parameters of the machine learning module based on the first measurement data and the second measurement data;
generating a prediction result based on the third reference dies; and
comparing the prediction result and the third measurement data, wherein the verification result is generated based on the comparison.

5. The method of claim 1, wherein encoding the process data to obtain preprocessed process data includes:
converting text data included in the process data into numerical data; and
extracting training data for the machine learning module from the preprocessed process data.

6. The method of claim 1, wherein:
the arithmetic module comprises at least one of an interpolation operation and an extrapolation operation.

7. The method of claim 1, wherein:
the first dies include first reference dies of at least one measured wafer,
the second dies include second reference dies of at least one unmeasured wafer, and
the third dies include first remaining dies of the at least one measured wafer and second remaining dies of the at least one unmeasured wafer.

8. The method of claim 7, wherein computing the second prediction data further comprises:
computing third prediction data of the first remaining dies based on the measurement data;
generating a verification result by performing a data verification operation on the at least one measured wafer based on the third prediction data; and
generating fourth prediction data of the second remaining dies based on the verification result.

9. The method of claim 7, wherein computing the second prediction data further comprises:
computing fifth prediction data of the second remaining dies based on the first prediction data;
generating a verification result by performing a data verification operation on the at least one unmeasured wafer based on the first prediction data and the fifth prediction data; and
generating sixth prediction data of the first remaining dies based on the verification result.

10. The method of claim 1, wherein:
the machine learning module comprises a plurality of boosting models.

11. The method of claim 1, wherein:
the first dies and the second dies correspond to a same coordinates of different wafers.

12. The method of claim 1, wherein:
the process data includes at least one of design layout data of the semiconductor dies, equipment data of a manufacturing process performed on the semiconductor dies, recipe data of the manufacturing process, and reticle data of the manufacturing process.

13. A method supporting manufacture of semiconductor dies, the method comprising:
performing a first manufacturing process on semiconductor dies, wherein the semiconductor dies include first dies, second dies, and third dies;
obtaining first process data and first measurement data of a feature of the first dies;
generating, using a machine learning module, first prediction data of the second dies based on the first process data and the first measurement data;
computing, using an arithmetic module, second prediction data of the third dies based on the first measurement data and the first prediction data;
generating first feature data including full-die level information of the semiconductor dies based on the first measurement data, the first prediction data, and the second prediction data;
obtaining second process data by performing a second manufacturing process;
training a machine learning module based on the first feature data and second process data; and
generating, using the trained machine learning module, second feature data of the semiconductor dies.

14. The method of claim 13, wherein:
the first feature data include geometric characteristics of patterns or edges of the patterns formed based on the first manufacturing process.

15. The method of claim 14, wherein generating the first prediction data further comprises:
encoding the first process data to obtain preprocessed process data; and
extracting training data for the machine learning module from the preprocessed process data based on the geometric characteristics, wherein the first prediction data is generated based on the training data.

16. The method of claim 13, wherein generating the first prediction data further comprises:
performing a reliability verification operation on the machine learning module.

17. The method of claim 13, wherein:
the arithmetic module comprises at least one of an interpolation operation and an extrapolation operation.

18. The method of claim 13, wherein:
the machine learning module comprises a plurality of boosting models.

19. An electronic device supporting manufacture of semiconductor dies, the electronic device comprising:
at least one processor;
at least one memory configured to store process data of the semiconductor dies and measurement data associated with features of first dies among the semiconductor dies;
a machine learning module comprising parameters stored in the at least one memory and trained to generate first prediction data associated with the features of second dies among the semiconductor dies based on the measurement data and encoded process data of the process data; and
an arithmetic module comprising parameters stored in the at least one memory and configured to compute second prediction data associated with the features of third dies among the semiconductor dies based on the measurement data and the first prediction data, and generate full-die level information based on the measurement data, the first prediction data, and the second prediction data, wherein the full-die level information representing features of the semiconductor dies.

20. The electronic device of claim 19, wherein:
each of the features of the first dies, the second dies, and the third dies represents a geometric characteristic of patterns formed during a manufacturing process of the semiconductor dies or edges of the patterns.
